(19) United States
(12) Patent Application Publication
(10) Pub. No.: US 2023/0337765 A1
(43) Pub. Date: Oct. 26, 2023

(54) AIR-FILTERING FACE MASK WITH ADJUSTABLE STRAPS

(71) Applicant: Bhuvi Raxwal, Tampa, FL (US)

(72) Inventor: Bhuvi Raxwal, Tampa, FL (US)

(21) Appl. No.: 18/346,182

(22) Filed: Jun. 30, 2023

(51) Int. Cl. A41D 13/11; A62B 23/02

(52) U.S. Cl. CPC A41D 13/1161; A41D 13/1138; A62B 23/02

(57) ABSTRACT

An air-filtering face mask designed to provide effective respiratory protection is described that combines comfort, versatility, and reliable protection. The face mask includes a mask body having one or more layers, allowing the wearer to breathe comfortably while using the mask. The mask body is reversible, providing the option for use on both sides, also the mask body is constructed with air holes, facilitating efficient airflow and effective filtration of harmful pollutants. Additionally, a pocket is attached to the mask body, enabling insertion and secure retention of at least one filtration unit for efficient air filtration. The mask is held in place on the wearer's face by a fastener that incorporates a pair of fastening elements, allowing the wearer to adjust the length of the fastener to achieve an optimal fit corresponding to their face size and shape.

### TECHNICAL FIELD

The present disclosure relates to air-filtering face masks, and more particularly relates to an air-filtering mask designed for respiratory protection, specifically focusing on construction, materials, and functionality of mask body, filtration capabilities, and adjustable fastening mechanisms.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Air pollution has become a critical global issue, with severe implications for public health and well-being. The inhalation of airborne pollutants, including particulate matter and harmful gases, has been linked to various respiratory diseases and adverse health effects. As a result, there is a growing need to develop effective respiratory protection measures.

Conventional face masks often face challenges in striking a balance between filtration efficiency and breathability. While high filtration efficiency is essential for capturing and removing airborne particles, it can lead to increased airflow resistance, causing discomfort and breathing difficulties for the wearer. This trade-off between filtration and breathability has hindered the widespread adoption of face masks as a reliable solution for respiratory protection.

Furthermore, the availability of cost-effective respiratory protection options that can cater to the diverse needs of individuals remains limited. Many existing face masks on the market are either prohibitively expensive or lack the necessary filtration capabilities to effectively combat air pollution. This leaves individuals with few accessible choices to safeguard their respiratory health.

There is, therefore, a need in the art for advancements in facemask design and functionality to overcome the limitations of existing face masks.

### SUMMARY

Various embodiments of the present disclosure relate to air-filtering face masks, and more particularly relates to an air-filtering mask designed for respiratory protection, specifically focusing on construction, materials, and functionality of mask body, filtration capabilities, and adjustable fastening mechanisms.

An aspect of the present disclosure pertains to an air-filtering face mask that offers a comprehensive solution to address the challenges of air pollution and respiratory protection. The face mask is designed with one or more layers of silk and cotton fibers, providing a high level of filtration efficiency while ensuring breathability and comfort. It features a reversible design, allowing for versatile use on both sides and enabling style and color coordination. Additionally, the face mask includes a pocket for inserting and securely holding filtration units such as activated carbon or HEPA filters, allowing for customizable filtration capabilities based on individual needs. The fastener, equipped with adjustable-length elements, ensures a personalized fit that accommodates various face sizes and shapes.

In another aspect, construction of the face mask includes a raised cup-shaped central portion, a rim portion, and a nose-bridge-contacting portion. The rim and nose-bridge-contacting portions are densely compacted, providing structural strength and resistance to airflow, while the raised central portion fits snugly over the wearer's mouth and nostrils.

In yet another aspect, the face mask effectively filters out harmful pollutants while allowing for comfortable breathing. It addresses the global concern of air pollution by offering an affordable and efficient solution that promotes public health and well-being.

Various objects, features, aspects and advantages of the inventive subject matter will become more apparent from the following detailed description of preferred embodiments, along with the accompanying drawing figures in which like numerals represent like components.

### OBJECTS OF THE INVENTION

It is an object of the present disclosure to provide a face mask that provides a comfortable breathing experience while maintaining structural integrity.

It is an object of the present disclosure to provide a face mask that is combination of the raised cup-shaped central portion and the reinforced rim and nose-bridge-contacting portions ensuring both comfort and strength, and allowing the wearer to breathe easily while still benefiting from effective filtration.

It is an object of the present disclosure to provide a face mask that includes adjustable face mask straps to enhance overall fit of the mask, and the personalized fit minimizes air leakage, leading to improved filtration efficiency and reducing the transmission of contaminants. The adjustable feature of the face mask straps allows the wearer to customize the fit to their individual face size and shape, ensuring a secure and comfortable fit.

It is an object of the present disclosure to provide a face mask that includes a replaceable filter to provide customization options for different levels of filtration.

It is an object of the present disclosure to provide a face mask that is designed to be soft and gentle on skin, reducing the risk of irritation or chafing. It is made of durable and fade-resistant material, ensuring longevity and maintaining its performance even with repeated use.

### BRIEF DESCRIPTION OF THE DRAWINGS

The accompanying drawing is included to provide a further understanding of the present disclosure, and is incorporated in and constitute a part of this specification. The drawing illustrates exemplary embodiment of the present disclosure and, together with the description, serve to explain the principles of the present disclosure.

FIG. 1 illustrates a perspective view of an exemplary air-filtering face mask, in accordance with embodiments of the present disclosure.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the spirit and scope of the present disclosures as defined by the appended claims.

Embodiments of the present disclosure relates to air-filtering face masks, and more particularly relates to an air-filtering mask designed for respiratory protection, specifically focusing on construction, materials, and functionality of mask body, filtration capabilities, and adjustable fastening mechanisms.

An embodiment of the present disclosure pertains to an air-filtering face mask that offers a comprehensive solution to address the challenges of air pollution and respiratory protection. The face mask is designed with one or more layers of silk and cotton fibers, providing a high level of filtration efficiency while ensuring breathability and comfort. It features a reversible design, allowing for versatile use on both sides and enabling style and color coordination. Additionally, the face mask includes a pocket for inserting and securely holding filtration units such as activated carbon or HEPA filters, allowing for customizable filtration capabilities based on individual needs. The fastener, equipped with adjustable-length elements, ensures a personalized fit that accommodates various face sizes and shapes.

In another embodiment, construction of the face mask includes a raised cup-shaped central portion, a rim portion, and a nose-bridge-contacting portion. The rim and nose-bridge-contacting portions are densely compacted, providing structural strength and resistance to airflow, while the raised central portion fits snugly over the wearer's mouth and nostrils.

In another embodiment, the face mask effectively filters out harmful pollutants while allowing for comfortable breathing. It addresses the global concern of air pollution by offering an affordable and efficient solution that promotes public health and well-being.

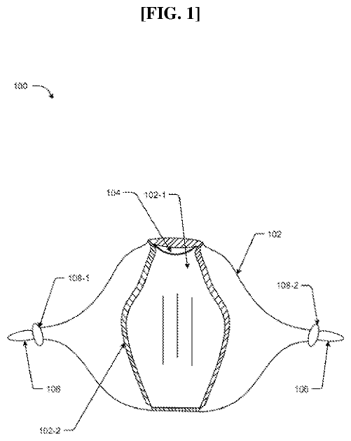

The manner in which the proposed apparatus works, is described in further detail in conjunction with FIG. 1. It may be noted that this figure is only illustrative, and should not be construed to limit the scope of the subject matter in any manner.

FIG. 1 illustrates a perspective view of an exemplary air-filtering face mask 100, in accordance with embodiments of the present disclosure. As illustrated, the face mask 100 includes a mask body 102 made of one or more layers, which allows a wearer to breathe while using the face mask, and the mask body is designed for reversible use on both sides. The one or more layers of the mask body can be made from various materials, including silk fiber and cotton fiber, individually or in combination. Additionally, the mask body 102 may incorporate a plurality of air holes strategically placed throughout its structure. These air holes serve two purposes: enabling efficient airflow and facilitating the filtration of a wide range of harmful pollutants. By allowing air to pass through the mask body, the wearer can experience improved breathability while still benefiting from effective filtration.

In an exemplary embodiment, silk fibers are recognized for their inherent ability to filter out pollutants from the air, making them an excellent choice for respiratory protection. On the other hand, cotton fibers are known for their softness and comfort against the skin. By blending these two types of fibers, the resulting fabric achieves a dual advantage. The hybrid fabric (i.e. silk fibers and cotton fibers effectively filters out pollutants due to the filtration properties of silk fibers. The silk fibers have a fine texture that can trap and block microscopic particles, such as dust, allergens, and other airborne contaminants, enhancing the mask's filtration efficiency. This feature ensures that the wearer is protected from harmful pollutants in the surrounding environment. The cotton fibers contribute to the overall comfort of the mask. Cotton is a breathable and soft material that feels gentle against the skin, minimizing irritation or discomfort during prolonged use. The inclusion of cotton fibers in the fabric helps ensure a pleasant wearing experience, making the mask more tolerable for extended periods.

In an embodiment, the mask body 102 consists of three distinct parts a raised cup-shaped central portion 102-1, a rim portion 102-2, and a nose-bridge-contacting portion. The raised cup-shaped central portion 102-1 is specifically designed to fit over the mouth and nostrils of the wearer. Its shape and positioning ensure that it covers these areas adequately, providing a protective barrier against airborne particles. Moreover, the raised cup-shaped central portion 102-1 is contoured to match the contours of the wearer's mouth and nostrils, allowing for a snug and secure fit. This contoured fit enhances the effectiveness of the mask by minimizing gaps and improving overall seal. The rim portion 102-2 extends around the raised cup-shaped central portion and serves as a support structure. It provides additional reinforcement and stability to the mask body. The nose-bridge-contacting portion, as the name suggests, comes into contact with the wearer's nose bridge and helps secure the mask in place.

In an exemplary embodiment, fibers used in the rim portion and nose-bridge-contacting portion of the mask body are densely compacted compared to the fibers in the raised cup-shaped central portion. This denser arrangement of fibers in these areas enhances the structural integrity of the mask. It makes the rim and nose-bridge-contacting portions stronger and more resistant to the flow of air. By contrast, the fibers in the raised cup-shaped central portion may have a looser arrangement, prioritizing breathability and comfort without compromising the overall effectiveness of the mask.

In an embodiment, the mask body 102 includes a pocket 104 attached to the mask body. The pocket 104 serves as a designated space where the filtration unit(s) can be easily inserted. This design feature enables the user to conveniently add or replace the filtration unit(s) as needed. The flexibility to insert multiple filtration units provides options for enhanced filtration performance and customization based on individual preferences and environmental conditions. The filtration units that can be inserted into the pocket include various types, such as activated carbon filters and HEPA filters. Activated carbon filters are known for their ability to adsorb and remove certain gases, odors, and volatile organic compounds (VOCs) from the air. HEPA (High-Efficiency Particulate Air) filters are highly efficient in capturing small particles, including fine dust, allergens, and microorganisms.

By incorporating the pocket 104 and allowing the use of different filtration units, the mask provides the wearer with the flexibility to adapt the level and type of filtration based on their specific needs and the air quality in their environment. This embodiment offers versatility and effectiveness in air filtration, enhancing the overall performance and utility of the face mask.

Continuing further, the mask body 102 includes a fastener 106 to hold the mask body in place on face of the wearer, including a first portion that engages with the mask body and a second portion that engages with the wearer. The fastener 106 includes a pair of fastening elements 108 designed to be adjustable, allowing the wearer to customize the length of the fastener based on their face size and shape. This adjustability feature enhances the overall fit of the mask, providing a snug and personalized experience.

The fastener 106 includes a pair of ear straps 106-1 and 106-2 that extend from both sides of the mask body and are configured to be hooked around one or more ears of the wearer. The pair of ear straps 106-1 and 106-2 are made of an elastic material which allows them to stretch and provide a secure grip around one or more ears of the wearer. The elastic nature of the ear straps ensures a comfortable fit without causing discomfort or irritation. Further, to enable easy adjustment and secure fastening, the fastener 106 includes a pair of fastening elements 108-1 and 108-2. These elements can be in the form of a locking mechanism or a buckle, which allows the wearer to securely adjust and lock the desired length of the fastener. This ensures that the mask remains in place throughout use, maintaining a proper seal and optimal filtration efficiency.

Above-disclosed face mask 100 has achieved significant advancements in respiratory protection and user comfort. With its multi-layered fabric construction, it offers high filter efficiency while maintaining breathability, striking a balance between filtration and comfort. The reversible design allows for versatile style and color coordination, catering to individual preferences. The adjustable strap ensures a personalized fit, enhancing comfort and minimizing air leakage, thereby improving filtration efficiency. The presence of a filter pocket enables customization of filtering capabilities, accommodating different levels of filtration based on specific needs. The densely compacted fibers in the rim and nose-bridge-contacting portions provide structural strength and a comfortable breathing experience. Moreover, the disclosed face mask combines filtration effectiveness, breathability, personalized fit, and cost-effectiveness, addressing the limitations of conventional masks and offering comprehensive respiratory protection for the wearer.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE INVENTION

The present disclosure provides a face mask that ensures both comfort and structural integrity, providing a pleasant breathing experience.

The present disclosure provides a face mask that combines a raised cup-shaped central portion with a reinforced rim and nose-bridge-contacting portions in a face mask, resulting in both comfort and strength. This design allows the wearer to breathe easily while benefiting from effective filtration.

The present disclosure provides adjustable face mask straps into the mask to improve the overall fit. The personalized fit minimizes air leakage, leading to enhanced filtration efficiency and reduced transmission of contaminants. The adjustable feature of the face mask straps enables customization for an individual's face size and shape, ensuring a secure and comfortable fit.

The present disclosure provides a face mask that includes a replaceable filter in the face mask, offering customization options for different levels of filtration.

The present disclosure provides a face mask that is gentle on the skin, reducing the risk of irritation or chafing. The mask is made of durable and fade-resistant material, ensuring long-lasting performance even with repeated use.

I/We claim:

1. An air-filtering face mask (100) comprising:
a mask body (102) made of one or more layers, allows a wearer to breathe while using the face mask, and the mask body is designed for reversible use on both sides;
a pocket (104) attached to the mask body, enable insertion and retention at least one filtration unit to facilitate air filtration; and
a fastener (106) to hold the mask body in place on a face of the wearer, comprises a first portion that engages with the mask body and a second portion that engages with the wearer, and the fastener comprises a pair of fastening elements (108) to enable the wearer to adjust length of the fastener corresponding to face size and shape.

2. The face mask as claimed in claim 1, wherein the one or more layers comprise any or a combination of silk fiber and cotton fiber.

3. The face mask as claimed in claim 1, wherein the mask body is constructed with a plurality of air holes to enable efficient airflow and filter a plurality of harmful pollutants.

4. The face mask as claimed in claim 1, wherein the mask body further comprises a raised cup-shaped central portion (102-1) adapted to fit over mouth and nostrils of the wearer, and a rim portion (102-2) extending around the raised cup-shaped central portion and a nose-bridge-contacting portion.

5. The face mask as claimed in claim 4, wherein fibers of the rim portion and nose-bridge-contacting portion are densely compacted compared to the fibers in the raised cup-shaped central portion.

6. The face mask as claimed in claim 4, wherein the raised cup-shaped central portion is contoured to fit the contours of the mouth and nostrils of the wearer, to provide a snug fit.

7. The face mask as claimed in claim 1, wherein the fastener comprises a pair of ear straps that extend from both sides of the mask body and are configured to be hooked around one or more ears of the wearer.

8. The face mask as claimed in claim 7, wherein the pair of ear straps are made of an elastic material.

9. The face mask as claimed in claim 7, wherein the pair of fastening elements comprises any of a locking mean or a buckle.

10. The face mask as claimed in claim 1, wherein the at least one filtration unit inserted into the pocket comprises any or a combination of activated carbon filter, and HEPA filter.
